(19) United States
(12) Patent Application Publication
(10) Pub. No.: US 2010/0018979 A1
(43) Pub. Date: Jan. 28, 2010

(54) 18" roller pan liner

(76) Inventor: Jesse Jacob Shumaker, Auburn, WA (US)

Correspondence Address: JESSE JACOB SHUMAKER, 29722 52ND AVE. S., AUBURN, WA, 98001, US

(21) Appl. No.: 12/070,631

(22) Filed: Jul. 24, 2008

(51) Int. Cl. B05C 21/00

(52) U.S. Cl. 220/570

(57) ABSTRACT

The new liner is the first ever to be produced for 18 inch roller pans. It enables painters to drop the new liner in the 18 inch roller pan, add paint and begin painting immediately. Painters can switch colors much faster than before by simply tying off the top of the liner, with included rubber band, and replace with a new liner and paint color. They can then switch back to the previous color if needed for second application or touch-up. The liner are thick so the paint will not dry out when sealed at the top. This enables the liners to be re-used several times. When finished clean up is much faster and neater.

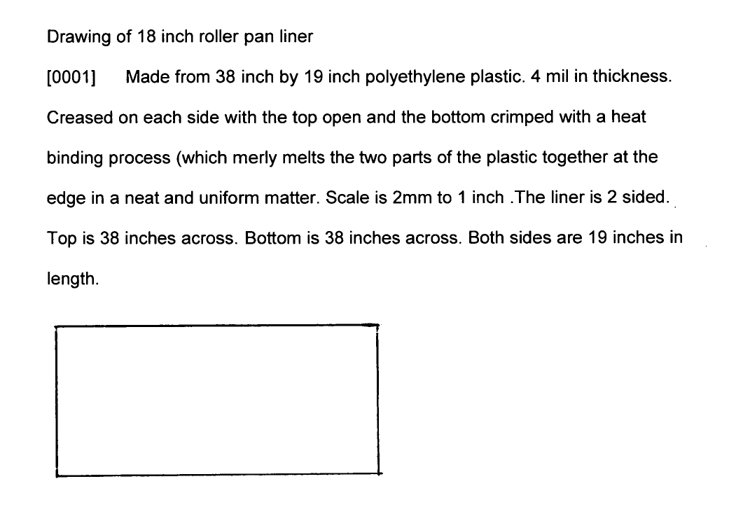

18 inch roller pan liners for all major 18 inch roller pans used in exterior and interior house painting. Jesse Jacob Shumaker, United States of America citizenship.

### SPECIFICATIONS

A 38 inch by 19 inch, 4 mil thick plastic liner for large professional sized roller pans used in exterior and interior painting. It is the first roller pan liner to be manufactured specifically for all major brand 18 inch roller pans.

### BACKGROUND

This plastic liner is made for rolling pans which hold paint, specifically for all major 18 inch roller pans used by professional interior/exterior painters. Previously no liners for this application were available. This new liner provides a clean painting surface for rollers used in painting walls and ceilings. Colors can be switched and stored easily by changing to a new liner. Previous to this invention painters would have to use the pan alone with no liner. After application they would let the remaining paint dry in the pan and scrape out when dry for re-use. This new liner has never, to the inventors knowledge, been manufactured in the specific size and thickness provided by my new 18 roller pan liners.

### SUMMARY

This liner saves time and money. The user is able to switch and store colors faster than the previous practice of using no liners for this size or roller pan. It also saves time with easy clean up and can be stored by tying off the top of the liner like a sack, with the provided rubber band. One size fits all major 18 inch roller pans.

### BRIEF DESCRIPTION OF DRAWING

One page of a drawing. Contains a drawing and dimensions of the liner.

### DETAILED DESCRIPTION

This liner is 4 mil in thickness. The size is 38 inches by 19 inches. It is made of a poly/plastic blend, 20 percent low density plastic and 80 percent linear density plastic. The liner is 2 sided. It has a solid seam across the bottom of 38 inches and is open across the top. The liner is made specifically for 18 inch roller pans, which hold paint and are marketed to professional production painters. It folds out in the pan to provide a clean painting surface for the 18 inch rollers used in painting interior or exterior painting.

1. The 18 inch roller pan liners have never, to the inventors knowledge, been produced before. In previous painting jobs, roller pans (the type that allow you to paint walls with a roller) would have to be dried out and scraped to change colors or to put away for storage. These new liners make it possible for the professional painter to neatly and quickly store or change colors of paints during interior/exterior painting jobs.
